(19) United States
(12) Patent Application Publication
(10) Pub. No.: US 2005/0120473 A1
(43) Pub. Date: Jun. 9, 2005

(54) Hydrotherapy circulation and cleaning system

(76) Inventors: Brian Southon, Oakville (CA); Eugene McDougall, Oakville (CA)

Correspondence Address: Ralph A. Dowell of DOWELL & DOWELL P.C., 2111 Eisenhower Ave., Suite 406, Alexandria, VA, 22314, US

(21) Appl. No.: 10/947,542

(22) Filed: Sep. 23, 2004

Related U.S. Application Data
(60) Provisional application No. 60/504,956, filed on Sep. 23, 2003.
(60) Provisional application No. 60/599,035, filed on Aug. 6, 2004.

(51) Int. Cl. A61H 33/04

(52) U.S. Cl. 4/541.6

(57) ABSTRACT

A spa, whirlpool or hot tub hydrotherapy system comprised of a unitized pump and motor assembly to provide a pipeless water circulation and air injection system that is easy to clean. The system can optionally provide an ionization device, which injects a stream of silver, copper and zinc ions into the water to kill bacteria, mold and algae, and solid-state lighting.

This application relates to U.S. Provisional Applications 60/504,956 filed Sep. 23, 2003 and 60/599,035 filed Aug. 6, 2004.

### FIELD OF INVENTION

The present invention relates to the field of water circulation and sterilization systems for hot tubs, bathtubs, foot spas, and the like.

### BACKGROUND AND SUMMARY OF THE INVENTION

In typical current piped spa water circulation systems, a centralized pump is used to pump water from the tub, to the pump and then back to the tub, through a piping system. Water trapped in the pipes after the tub is drained has been proven to promote the growth of bacteria, algae, fungus and molds. This is known to be a serious health hazard, as well as being objectionable to clients who do not want to soak in another person's bacteria.

In the current invention, this piping is unnecessary since the motor and impeller are situated right behind the jets. The impeller pulls water in form the pool, and exhausts it directly back into the pool.

The impeller pump housing may be configured with a removable front cover. Further, the front cover may be configured with one or more water conduits to direct the flow of water as it leaves the impeller to form water jets. The front cover may be easily removed, thereby exposing all water conduits and wetted surfaces for easy cleaning and sterilization. Multiple front covers may be removably attached to the impeller pump housing, in this manner, to allow for the interchange of various jets for different applications and/or re-directing water flow. Further, some front covers may be configured with a spa illumination system, and/or an ionization system, or other features. Power for these features may be obtained through a magnetically coupled air gap transformer, retaining the ability to easily remove the front cover for cleaning and other purposes since no electrical contacts are required.

Prior art in this field has utilized open frame electric motors with shafts that connect to an impeller. The water is retained in the tub by using a single seal on the motor shaft. If the seal leaks, water will enter the motor area causing motor failure and possibly allowing electric current to flow back along the metal motor shaft and into the tub, thereby creating a shock hazard. Of note is the fact that the electrical components of the motor, in this configuration, cannot be encased in a plastic or other type of insulating barrier since the motor and impeller are directly rather than magnetically coupled.

Open frame motors often have built in cooling fans that force air and dust into the motor. This dust may collect in the motor area, hampering cooling and causing the motor to overheat over time.

The present invention teaches several unique safety features, such as a magnetically coupled shaft that is not subject to leakage, no cooling fans, and a sealed motor with an integrated heat exchanger, substantially reducing the risks associated with over heating and electrical shock.

The current invention creates and maintains a substantially bacteria free environment by providing a cleanable jet system optionally coupled with a silver ionization system to provide the bactericide. Prior art relies totally on the cleaning process which may or may not be followed by the staff, It is extremely difficult to make a tub bacteria-free when a cloth is used to wipe out the impeller housing.

In a system disclosed in U.S. Pat. No. 5,587,023, the impeller itself is a complicated and multi-surfaced part that needs to be placed in a sterilization clavicle in order to render it bacteria-free. Wiping it off with a cloth will only remove larger dirt and debris but does not render it clinically sterile.

The present invention teaches a simpler impeller design that is easier to clean and may optionally use silver and copper ions to attack and kill bacteria, even it the cleaning procedure is not rigorously followed. The silver and copper ions continue killing bacteria during the spa session, including the client's own bacteria. In many prior art systems, the water is immediately infested with bacteria as soon as the client puts their feet into the water. Thus a user continues to bathe in bacteria regardless of how well the system was cleaned.

### BRIEF DESCRIPTION OF THE DRAWINGS

Embodiments of the invention are described by way of example with reference to the following diagrams in which;

FIG. 1 provides an overview of the hydrotherapy circulation and cleaning system installed in a spa,

FIG. 2 is a top view of the hydrotherapy circulation and cleaning system,

FIG. 3 is a front view of the front cover,

FIG. 4 is a front view of the flow control plate,

FIG. 5 is a side view of the hydrotherapy circulation and cleaning system with an air venturi,

FIG. 6 is a section view of the hydrotherapy circulation and cleaning system, snowing the basic components of the ionization system,

FIG. 7 is a section view of a stand-alone ionization system,

FIG. 8 is a block diagram of the ionization system, and

FIG. 9 provides further detail regarding the ionization system.

### DETAILED DESCRIPTION OF THE INVENTION

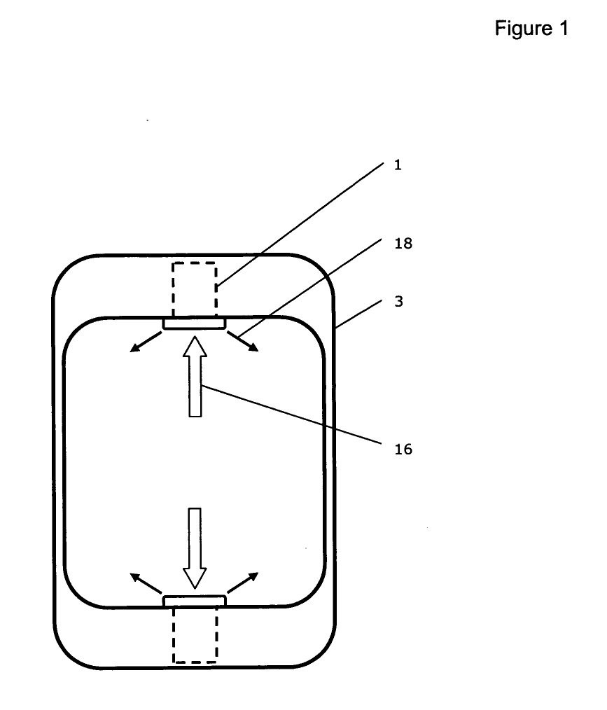

FIG. 1 provides an overview of hydrotherapy circulation and cleaning system 1 installed in spa 3 One or more hydrotherapy circulation and cleaning systems 1 may be installed in a hot tub, bathtub, spa, foot spa, medical bath, or other therapeutic device.

Hydrotherapy circulation and cleaning system 1 may be configured with a motor and an impeller to create a centrifugal pump that draws inlet flow 16 into the system, and exhausts the flow directly back into spa 3, under increased pressure, as water jets 18. The velocity, direction, and quantity of water jets 18 may be adapted to suit a variety of applications. Further, air may be added to water jets 18 to enhance the hydrotherapy effects.

Hydrotherapy circulation and cleaning system 1 is an integrated system that requires no pipes, and therefore it may be referred to as a pipeless system. This greatly enhances the inherent cleanliness and safety of the system since there are no areas of standing water to collect bacteria and molds between uses. Further, hydrotherapy circulation and cleaning system 1 may be configured with a removable front cover to provide easy access to the impeller and other wetted surfaces for sanitization.

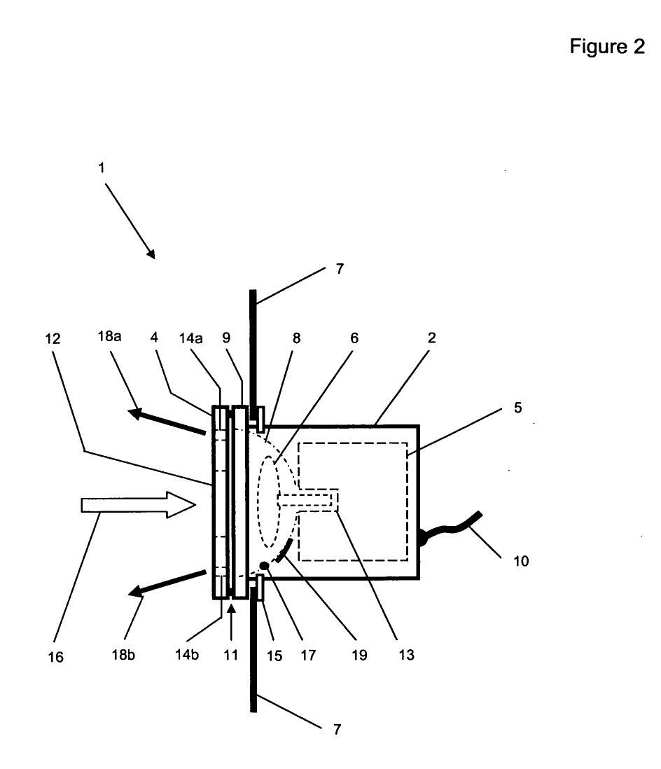

FIG. 2 is a top view of hydrotherapy circulation and cleaning system 1, with pump housing 2 and front cover 4. Pump housing 2 contains pump motor 5 and impeller 6, which rotates freely within flow directing cavity 8. Power is supplied to pump motor 5 through power cord 10.

Pump motor 5 may be an AC synchronous motor that uses magnetic coupling between the coils and the rotor. Further, the rotor may be mechanically attached to, or an integral part of, impeller 6. A thin plastic or other type of insulating barrier may be configured between the coils and the rotor, i.e. between pump motor 5 and impeller 6, to substantially reduce the shock hazard that may be associated with using impeller 6 in a spa or other type of water container. Further, the insulating barrier may be configured to form a sealed bearing surface for the rotor and impeller 6 assembly, allowing it to rotate freely within magnetically coupled bearing tube 13 while preventing water from entering pump motor 5.

The magnetically coupled configuration precludes the requirement for an O-ring type bearing seal that could burn out if the impeller runs dry, a dangerous situation that would allow water to enter the pump motor area and create a potential shock hazard for the user. Further, the magnetically coupled configuration allows pump motor 5 and all other electrical components to be completely sealed within pump housing 2, leaving only flow directing cavity 8 and magnetically coupled bearing tube 13 as open areas to accommodate the rotor and impeller 6 assembly.

Pump housing 2 may be configured to slide into a fixed size opening in tub wall 7 until inner flange 9 rests against the water side of tub wall 7. Pump housing 2 may be held in place, and inner flange 9 may be sealed against the water side of tub wall 7, with adhesives, mechanical fasteners such as rotating clips 15, or through some other convenient means. In one embodiment rotating clips 15 may be configured to conform to the outer geometry of pump housing 2 when not in use, allowing pump housing 2 to be installed through a minimum diameter hole in tub wall 7, and further configured to rotate outwards to engage with tub wall 7 during installation, allowing inner flange 9 to be compressed and sealed against tub wall 7 using clamp screws accessible from the water side of the tub or spa.

Front cover 4 may be installed by attaching it to inner flange 9. Front cover 4 may be held in place with clips that engage when front cover 4 is correctly positioned relative to inner flange 9, or through some other convenient means, such as a magnetic latch, made from neodymium or some other suitable material, that allows front cover 4 to be removed and replaced, for cleaning and other purposes. Further, a magnetic or other type of latch may be designed to automatically release at a preset pressure of, for example, 5 lb., such that it will release in response to excessive hair entrapment or other related problems. A magnetic latch may also be used for a secondary purpose such as activating a reed switch or hall effect device to turn off pump motor 5 when front cover 4 is removed.

Flow directing cavity 8 may be configured for easy access to impeller 6, so that flow directing cavity 8 and impeller 6 may also be thoroughly cleaned when front cover 4 is removed. All wetted surfaces of hydrotherapy circulation and cleaning system 1 may be easily cleaned and sanitized in this manner. Flange seal 11 substantially reduces leakage between the front cover 4 and inner flange 9, and ensures that a maximum amount of pressure and water volume is available for water jets 18a and 18b. Front cover 4 may also be configured with an alignment feature that engages with impeller 6 to ensure that the rotor is correctly aligned with pump motor 6 when front cover 4 is installed. An appropriate level of back pressure and correct alignment are both required to initiate the rotation of impeller 6 when front cover 4 is installed. Conversely, removing front cover 4 results in the lack of backpressure and sub-optimal alignment, stopping the rotation of impeller 6. This adds to the safety of hydrotherapy circulation and cleaning system 1 since impeller 6 may be configured to automatically stop rotating when front cover 4 is removed, in this manner. Further, an electronic, magnetic, or other type of interlock may be configured to disconnect the power to pump motor 6 when front cover 4 is removed, thereby providing an enhanced level of safety.

Front cover 4 may be configured with inlet ports 12 and outlet ports 14a and 14b. Inlet ports 12 may be of straight, wavy, circular, or any other type of design that is aesthetically pleasing and allows sufficient throughput. Water is drawn into the center of a rotating impeller 6 through inlet ports 12, as shown by inlet flow 16. Water is then pushed from the periphery of a rotating impeller 6, and channeled by flow directing cavity 8 through outlet ports 14a and 14b, with increased pressure and velocity, to produce water jets 18a and 18b.

The central inlet and peripheral outlet design may be configured with multiple outlets, producing multiple water jets and creating a higher level of hydrotherapy circulation than previously possible with a single pump. Impeller 6, inlet ports 12, flow directing cavity 8 and outlet ports 14a and 14b interoperate to form a centrifugal pump system. Other types of pump mechanisms are also possible.

Hydrotherapy circulation and cleaning system 1 may be adapted to include an efficient heater, heating the water from the tub or spa as it passes through flow directing cavity 8. Temperature sensor 17, mounted on the side of flow directing cavity 8, may be integrated with a bimetallic thermostat or an electronic means to control heater module 19, allowing power to flow from power cord 10 to heater module 19 when required. Heater module 19 may be sealed inside the wall of flow directing cavity for efficient transfer of heat to the water, and to prevent electrical shocks. Further, the back surface of heater module 19 may be insulated to ensure that a maximum amount of heat is transferred to the water, and to prevent pump motor 5 from overheating. Electronic or other types of control mechanisms may be adapted to provide adjustable set points and other related features.

Front cover 4 or inner flange 9 may be configured with a small hole at the bottommost point to allow water to drain from flow directing cavity 8 after pump motor 6 has been turned off, thus preventing the retention of stagnant water that would have encouraged bacterial growth. This represents a critical advantage over systems with pipes, since these traditional systems have several areas where water can stagnate and produce bacterial growth.

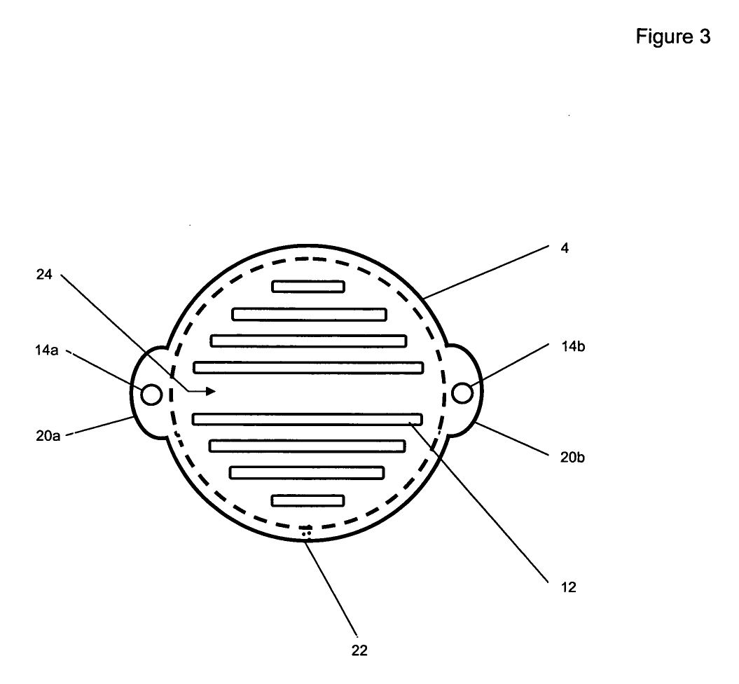

FIG. 3 is a front view of front cover 4, showing inlet ports 12 and outlet ports 14a and 14b. Multiple inlet ports 12 may be configured, as shown, to allow impeller 6 to draw water freely into flow directing cavity 8 (reference FIG. 2). Outlet ports 14a and 14b may be configured to form and direct the jet of water in order to create a maximum level of hydrotherapy effects within the tub or spa. Drain hole 22 allows water to drain from flow directing cavity 8 when the system is not in use, as previously described.

Outlet ports 14a and 14b may by configured within outlet protrusions 20a and 20b such that outlet protrusions 20a and 20b mate with equivalent protrusions on the perimeter of flow directing cavity 8 (reference FIG. 2). Further, outlet protrusions 20a and 20b may be designed to form convenient handles, easily accessed by the user's thumb and index fingers to rotate front cover 4 when removing and replacing it, for cleaning and other purposes.

Inlet ports 12 may be arranged to leave branding space 24 in the middle of front cover 4. Branding space 24 may be an interchangeable feature within the mould for front cover 4, allowing the component to be easily produced with a variety of language and/or brand markings. The user will intuitively install front cover 4 with the brand in a legible or upright position, ensuring that drain hole 22 is correctly positioned. Other positioning features may be added for greater clarity.

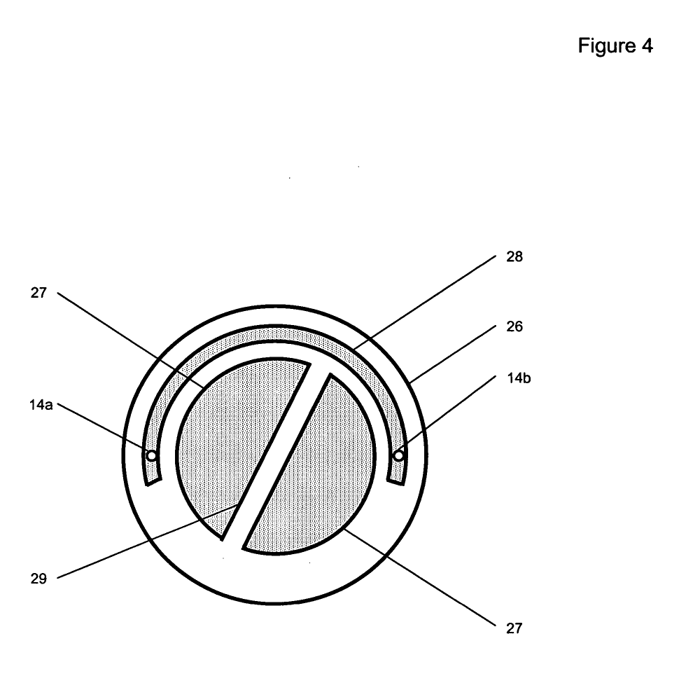

FIG. 4 is a front view of flow control plate 26, configured with inlet apertures 27 and outlet aperture 28. Flow control plate 26 may be rotatingly attached behind the front surface of front cover 4 such that water flows in through inlet ports 12 and inlet apertures 27. Flow control plate 26 may be left in a central position, as shown, to align outlet aperture 28 with both of outlet ports 14a and 14b and produce two water jets 18a and 18b. Alternatively, flow control plate 26 may be rotated clockwise to cover outlet port 14a, or counterclockwise to cover outlet port 14b, in order to produce a single water jet 18b or 18a, respectively. Flow control plate 26 may not be positioned to simultaneously block both outlet ports, ensuring a constant flow of water and preventing the overheating of pump motor 5 (reference FIG. 2).

Flow control plate 26 may also be configured to rotate automatically, producing a pulsating affect as it aligns outlet aperture 28 with outlet ports 14a and 14b on an alternating basis. This may be accomplished by coupling flow control plate 26 with impeller 6 when front cover 4 is installed, either through a mechanical, magnetic, or some other means Gears may be used to reduce the rotational speed of flow control plate 26, relative to that of impeller 6, if required (reference FIG. 2). Alternatively, flow control plate 26 may be fitted with vanes and allowed to rotate treely as the water swirls past and pushes against tne vanes. Further, a flow control plate with vanes may be fitted with a brake to prevent free rotation, and therefore stop the pulsating effect, when desired.

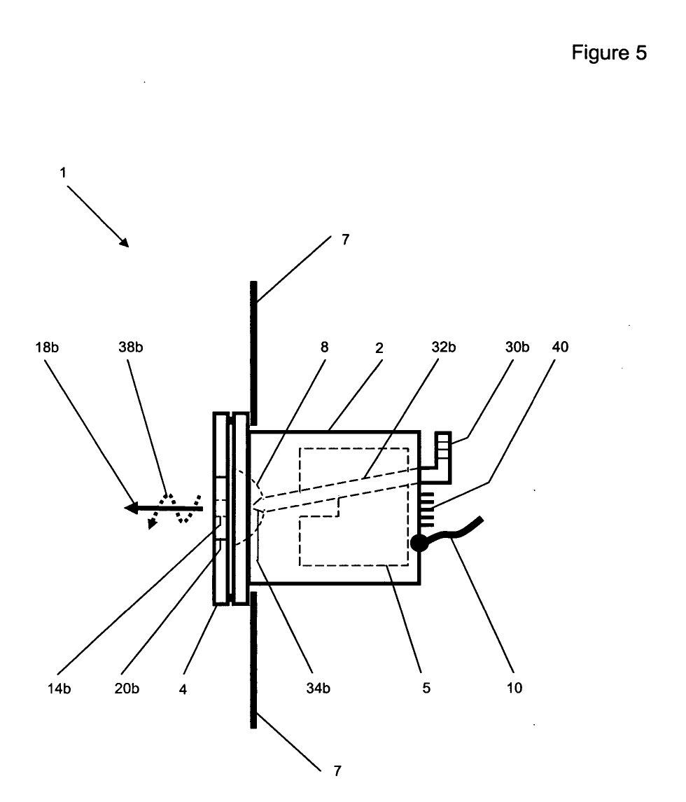

FIG. 5 is a side view of hydrotherapy circulation and cleaning system 1 with air venturi 34b. Hydrotherapy circulation system 1 operates as previously described, drawing water into flow directing cavity 8 and pushing it out through outlet port 14a, under increased pressure and with increased velocity, to form water jet 18a.

In this embodiment air venturi 34b may be configured and positioned within flow directing cavity 8 such that the flow of water through flow directing cavity 8 will draw through air venturi 34b, internal air passage 32b, and air fitting 30b at an appropriate rate. The air and the water will be pushed through outlet port 14b to form a combined water jet 18b and air bubble stream 38b. Outlet port 14b may be configured to mix and direct water jet 18b and air bubble stream 38b to create the most effective effervescent, and pleasing hydrotherapy circulation for a given application.

Air fitting 30b may be a standard barb Type fitting, extending up to but not past the outer extremity of pump housing 2 such that hydrotherapy circulation and cleaning system 1 may be installed through a minimum fixed size opening within tub wall 7.

Air fitting 30b may be designed to accept and retain a length of flexible tubing that extends the air opening to a location above the maximum possible water level in order to prevent the accidental draining of the tub or spa through air venturi 34b . Alternatively, the flexible tubing may be used to connect air fitting 30b to an external air flow controller. Further, the external air flow controller or other external connection point may be configured with a small funnel, or other type of removable or non-removable container, through which a bleach, peroxide, or other cleaning solution may be poured, and allowed to drain through and sanitize the air passages. In some applications the funnel may be sized to contain sufficient cleaning solution to sanitize the entire spa after flowing through air venturi 34b, and upon filing the spa and turning on hydrotherapy circulation and cleaning system 1 to draw in and re-circulate the cleaning solution for an appropriate period of time. Various other means of attachment, control, and automated cleaning are also possible.

Internal air passage 32b may be inclined slightly, as shown, such that any water that might flow back through air venturi 34b when hydrotherapy circulation and cleaning system 1 is turned off will automatically drain out of internal air passage 32b when the water level falls below air venturi 34b. Internal air passage 32b may be inclined to the extent that it will be self draining even when hydrotherapy circulation and cleaning system 1 is installed on a non-vertical surface, for example the wall of a tub or spa that has been designed with a draft angle for mould removal purposes.

A check valve may be installed at air venturi 34b to prevent the backflow of water into internal air passage 32b. In another embodiment, a check valve may be installed on air fitting 30b, preventing the backflow of water past air fitting 30b while still allowing water to drain out of internal air passage 32b when the water level drops below air venturi 34b.

Internal air passage 32b may be configured to run through, or in close proximity to, pump motor 5 such that heat generated by pump motor 5 may be absorbed by the air flowing through internal air passage 32b, and dispersed into the water through air bubble stream 38b. Further, internal air passage 32b and pump motor 5 may be sealed within pump housing 2 using a heat conducting potting compound in order to increase the transfer of heat between the two components, enhancing the cooling efficiency and increasing the amount heat from pump motor 5 that may be used to raise the temperature of the water. Further, the heat conducting potting compound may be used to facilitate the transfer of additional heat from pump motor 5 to pump housing 2 where it can be dispersed into the ambient air through integrated heat sink fins 40, using forced or natural convection. In certain applications it may be advisable to install a timer within, or external to, pump housing 2 to shut off pump motor 5 atter a pre-determined amount of time. Such timer may be further configured with a timer or other type of reset, a thermal fuse, or some other means to ensure that pump motor 5 does not overheat.

Although the right or “b” side of hydrotherapy circulation and cleaning system 1 has been used for illustration purposes, it will be understood that the discussion is equally applicable to the left or “a” side of hydrotherapy circulation and cleaning system 1, with reference to FIG. 2.

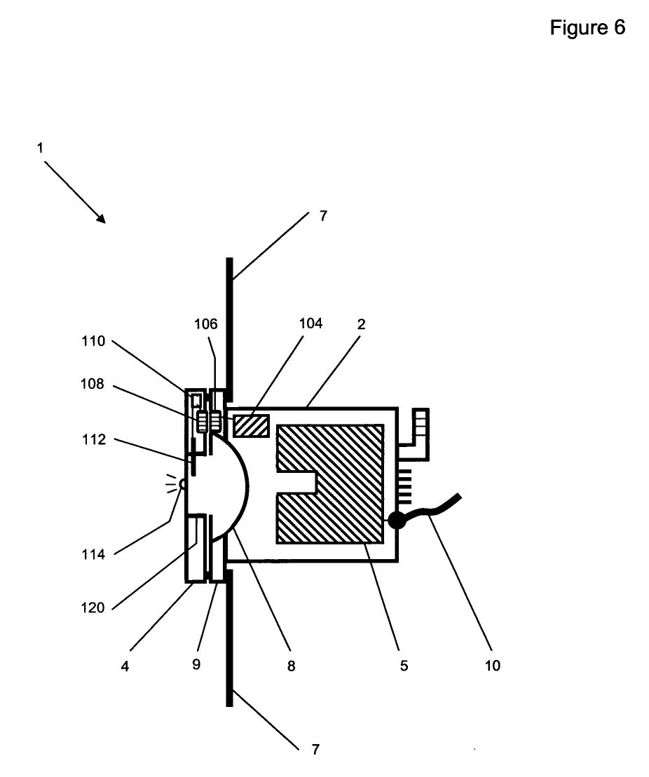

FIG. 6 is a section view of hydrotherapy circulation and cleaning system 1, showing the basic components of ionization system 100. Ionization system 100 may be configured with ionization controller 104 and drive coil 106, mounted within pump housing 2 and inner flange 9, respectively, and pickup coil 108, regulator 110, ionization electrodes 112, and indicator LED 114, mounted within front cover 4. Alternatively, indicator LED may be mounted within pump housing 2, and configured to be visible from the front of front cover 4 through fiber optics, a lens cover, or through some other means.

Drive coil 106 and pickup coil 108, when placed in close proximity, form an air gap transformer that transfers power from inner flange 9 to front cover 4 while still allowing the easy removal of front cover for cleaning and other purposes, as previously described. Power is converted to a usable form and then made available to ionization electrodes 112 and indicator LED 114 through regulator 110. Ionization electrodes may be configured within open area 120, allowing the circulation of spa water past ionization electrodes 112 as it passes through hydrotherapy circulation and cleaning system 1. Indicator LED 114 may be configured to illuminate when ionization electrodes are functioning properly.

Power delivered through drive coil 106 and pickup coil may be monitored to detect the condition of electrodes 112. This information may be used to shut down hydrotherapy circulation and cleaning system 1 when electrodes 112 reach end of life and cease to conduct an acceptable level of current, thereby preventing the use of the spa when ionization is not available. A further benefit of this feature is that hydrotherapy circulation and cleaning system 1 will only operate when front cover 4 is in place, since no power will be delivered through drive coil 106 when front cover 4, containing pickup coil 108, is removed.

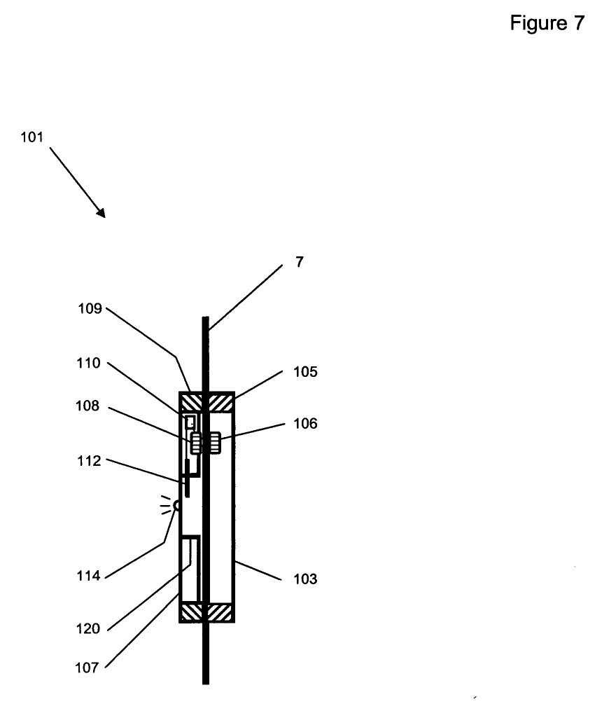

FIG. 7 is a section view of stand-alone ionization system 101. Stand-alone ionization system 101 may be mounted on tub wall 7, without cutting a hole in tub wall 7. Multiple stand-alone ionization systems 101 may be installed to produce the desired ionization effect in existing tubs or spas.

Back plate 103 may be permanently mounted on the dry side of tub wall 7, and configured with permanent magnet 105 and drive coil 106. Ionization plate 107 may be configured with pick-up coil 108 and retaining magnets 109. Ionization plate 107 may be detachably mounted on the wet side of tub wall 7 by aligning retaining magnets 109 with permanent magnets 105, such that pick-up Coil 108 is aligned with drive coil 106. Power is transferred from drive coil 106 to pick-up coil 108, energizing ionization electrodes 112 and indicator LED 114, as previously described.

Ionization plate 107 may be configured with open area 120, allowing the circulation of spa water past ionization electrodes 112. In this embodiment the movement of spa water is accomplished with the existing circulating pump system. Back plate 103, and therefore ionization plate 107, may be mounted in the flow of moving water for a maximum ionization effect. Further, multiple back plates 103 may be mounted at various locations around the spa wall, allowing a smaller number of ionization plates 107 to be moved to high flow and/or convenient locations while the spa is in use.

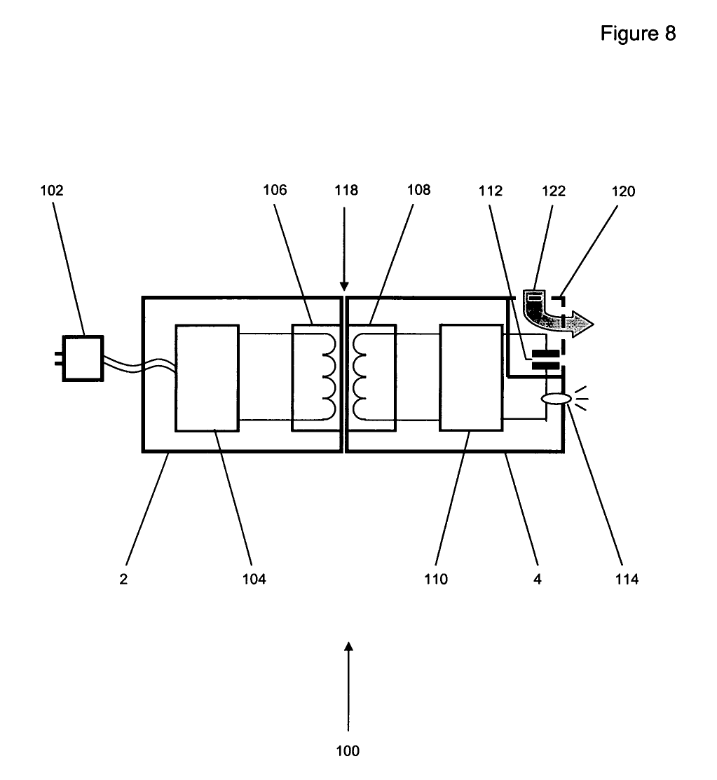

FIG. 8 Is a block diagram of the ionization system 100. Power may be supplied to ionization system 100 by ionization power supply 102 which may be of typical wall mount design, connected to the AC line and producing a lower DC voltage such as 15 VDC at 100 mA. Alternatively, power may be obtained from sources available within pump housing 2 (reference FIG. 6).

Power is controlled and then transferred through drive coil 106 to pickup coil 108, where it is available to regulator 110. Drive coil 106 and pickup coil 108 are separated by air gap 118, plus the material thicknesses of pump housing 108 and front cover 116 in this area. Air gap 118, which may be ideally reduced to zero when pump housing 2 and front cover 4 are in intimate contact, allows front cover 4 to be removed from pump housing 2 for cleaning and other purposes. Further, this configuration ensures that power will only be transferred to front cover 4, and the components contained therein, when front cover 4 is correctly mounted on pump housing 2.

Ionization controller 104 may be configured with an oscillator to drive a MOSFET or transistor circuit, providing pulsed power to drive coil 106 at a frequency of approximately 80 KHz. Further, ionization controller 104 may be configured to modulate the pulsed power according to certain commands. The commands may be represented as binary coded patterns in the pulsed power stream to be subsequently decoded by regulator 110. These commands may be hard wired, microprocessor controlled, or initiated by an optional Keyboard or touch pad for operator input.

Drive coil 106 may be buried slightly below the exposed surface of pump housing 2 or inner flange 9 (reference FIG. 6) such that it aligns with pickup coil 108 when front cover 4 is properly aligned with pump housing 2. Drive coil 106 may be sealed below the surface of pump housing 2 or inner flange 9, in this manner, so that it is not exposed to water or moisture in this area and does not present an electrical hazard when front cover 4 is removed. Further, the surface covering drive coil 106 will remain smooth and easy to clean.

Pickup coil 108 may be buried and sealed slightly below the exposed surface of front cover 4 in like manner, leaving the surfaces of front cover 4 easy to clean and free of electrical hazards.

Drive coil 106 and pickup coil 108 may be configured as straight coils with a single alignment point as front cover 4 is mounted on pump housing 2, and then rotated and “locked” into proper alignment. Alternatively, drive coil 106 and pickup coil 108 may be configured as semi-circular coils, mounted on an arc that is concentric with the circular geometry of front cover 4, such that front cover 4 may be rotated to create a full or partial alignment between drive coil 106 and pickup coil 108. This alternate configuration provides a simple means to control the level of power transfer between drive coil 106 and pickup coil 108, thereby controlling the amount of power that is supplied to ionization electrodes 112 and indicator LED 114, allowing for the control of ionization rates and LED intensity.

Regulator 110 may be configured with a full wave rectifier bridge and filter to convert the pulsed power provided by pickup coil 108 to a fluctuating DC voltage, which may be further regulated and modulated to provide the current switching and phase reversal required to drive ionization electrodes 112 and indicator LED 114. Regulator 110 may also be configured with a low voltage IC or Zener diode circuit to improve the quality of the DC power for use with a microprocessor or other type of controller.

Ionization electrodes 112 may be composed of silver, copper, and zinc in controlled proportions, suitable for ionization. Alternatively, stainless steel electrodes may be used for unipolar electrode operation. In either case, ionization electrodes may be exposed within open area 120, allowing the circulation of spa water 122 past ionization electrodes 112 as it passes through the hydrotherapy circulation and cleaning system.

Ionization electrodes 112 may be configured in series with indicator LED 114 such that indicator LED 114 will cease to function when ionization electrodes 112 become depleted to the extent that they stop conducting electricity. Indictor LED 114, when configured in this manner, indicates proper operation only when illuminated, alerting the user to replace ionization electrodes 112 when not illuminated. In one embodiment, ionization electrodes 112 may be replaced by simply installing a new front cover 4 on an existing pump housing 2.

Indicator LED 114 may also be used to illuminate the spa or hot tub with pleasing colors and effects. Indicator LED 114 may be mounted in the jet streams to highlight the effervescent quality of the circulating water. Further, multiple indicator LEDs may be mounted around the perimeter of front cover 106 to produce different colors or other color therapy effects.

Pump housing 2 may be configured with ionization controller 104 and drive coil 106, as described above, and installed with a passive front cover containing no ionization electrodes or other electronics. This is possible because Ionization controller 104 and drive coil 106 remain buried within, and undetectable from the outside of, pump housing 2. Further, ionization controller 104 and drive coil 106 remain inactive until connected to ionization power supply 102. These features allow pump housing 2 to be installed and used with a passive front cover 4, and then to be upgraded for use with an active front cover 4 at any time with the simple addition of ionization power supply 102. Other types of front covers, possibly containing only color therapy LEDs and no ionization electrodes, may be configured to use the power available from pump housing 108, and may be interchangeably installed in like manner.

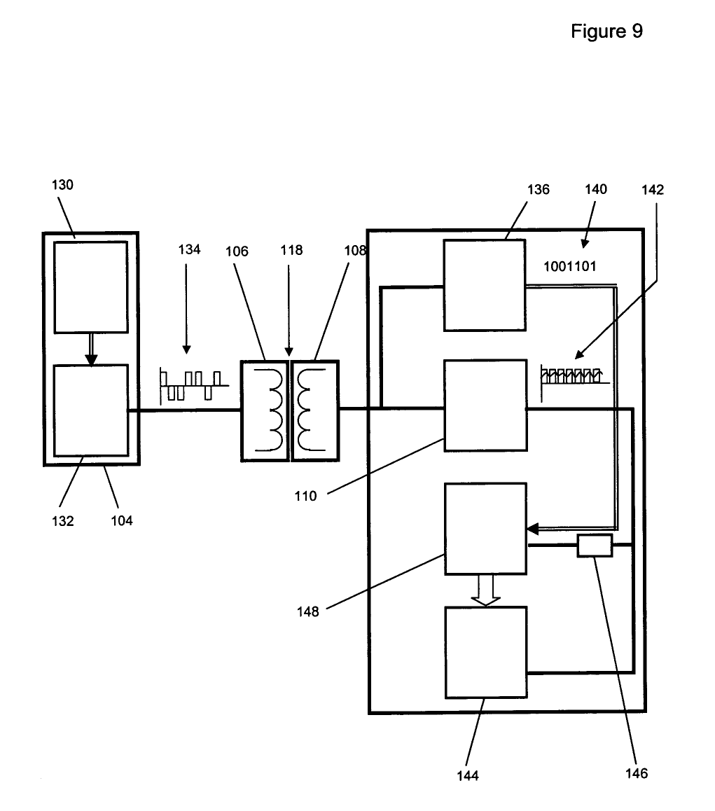

FIG. 9 provides further detail regarding ionization system 100, which may be configured to simultaneously transfer power and control information between drive coil 106 and pickup coil 108.

Ionization controller 104 may be configured with phase modulator 130 and drive circuit 132. Phase modulator 130 accepts commands from an internal microprocessor, external keyboard, or some other source and translates these commands into a series of phase modulated pulses that carry the control word information in binary format. Drive circuit 132 aids power and amplifies the pulses, while retaining the control word information, to generate phase modulated power 134.

Phase modulated power 134 is transferred through drive coil 106 and pickup coil 108, as previously described. In this configuration, however, the air gap transformer will simultaneously deliver power and control information to phase decoder 136 and regulator 110, for the decoding of commands and power conditioning, respectively.

The output from phase decoder 136 will be binary control code, in the form of serial command 140. The output from rectifier 138 will be regulated and modulated DC power, as represented by output power wave 142, which may be delivered directly to component controller 144. However further conditioning by regulator 146 may be required before the power is delivered to microprocessor 148.

Microprocessor 148 accepts serial commands 142 and decodes the information to control the ionization rate and timing for electrodes 112, indicator LED 114, and the color and sequencing of other LEDs that may be configured around the periphery of front cover 4 for spa illumination, color therapy, and other purposes (reference FIG. 8). Such control is exercised through component controller 144, which regulates power delivery to these components. Microprocessor 148 may also be configured to monitor the current delivered to electrodes 112, and programmed to provide a visual warning as electrodes 112 approach end of life.

The hydrotherapy circulation and cleaning system of the present invention allows for many applications, and may be implemented in several different embodiments to circulate, heat or cool, and clean fluids, and add gasses to fluids. Although reference is made to the embodiments listed above, it will be understood that these are only be way of example and to identify the preferred use of the device Known to the inventors at this time. It is believed that the hydrotherapy circulation and cleaning system of the present invention has many additional implementations and applications that will becomes obvious once one is familiar with the fundamental principles of the Invention.

1. A powered pipeless spa jet motor and pump system which draws in, accelerates and expels water back to a tub, pool or spa without the use of any enclosed piping.

2. The spa jet system of claim 1, which has one or more discrete outlet ports in the pump cavity which direct the water flow to a cover plate and through conduits in the cover plate then to be ejected with force at one or more output jets.

3. The spa jet system of claim 1, whereby the conduits themselves are formed in part when the cover plate is placed against the tub, utilizing the tub surface as part of the conduit.

4. The spa jet system of claim 1, whereby the cover plate can be removed without the use of tools, to expose all water conduits and pathways for cleaning but not necessarily fully sanitized or sterilized.

5. The spa jet system of claim 1, whereby one or more air venturii are used to create an air vacuum for the purpose of injecting air into the water stream.

6. The spa jet system of claim 5, wherein the air venturii pathways are brought into contact with a motor heat exchanger in order to cool the motor and warm tne air before the air is injected into the water stream.

7. The spa jet system of claim 1, wherein the pump and motor are enclosed in a thermally conductive enclosure that is in contact with the water thermally to provide heat transfer to the water

8. The spa jet system in claim 1, wherein shaft seals are not used to retain water from leaking from the tub.

9. The spa jet system of claim 1, whereby a totally enclosed rotor is used which is separated by a non-conductive barrier to prevent current flow into the tub area, further utilizing a magnetic coupling to convey energy from the stator to the rotor assembly without air insulation means.

10. The spa jet system of claim 1, further comprising silver/copper/zinc alloy and stainless steel electrodes to inject silver and copper and zinc ions into the water to provide a bactericide agent,

11. The system of claim 10, further comprising an LED indicator to indicate power to the system, and a second LED to indicate that the current is passing through tne electrodes during ionization.

12. The system of claim 10, wherein the ionization chamber is situated such that when the tub is drained, the water leaves the ionization chamber and ionization is stopped automatically by the loss of the conductive water media.

13. The system of claim 10, wherein the bactericide effect of the copper and silver, as well as the zinc ions in solution provide healthful effects for the skin while eliminating the harmful effects of chlorine commonly used to treat hot tub pool and spa water.

14. The system of claim 10, whereby after spa use, any residual water which may remain, has silver and copper ions still in the residual water.

15. The system of claim 10, whereby the ion levels build during the spa session and provides continually increasing bacteria killing effects for the duration of the session
